(19) United States
(12) Patent Application Publication
(10) Pub. No.: US 2024/0330832 A1
(43) Pub. Date: Oct. 3, 2024

(54) SERVICE LEVEL INDICATOR ANALYZER (SLI ANALYZER)

(71) Applicant: NOBL9 INC., Waltham, MA (US)

(72) Inventors: Alexander Lucas Hidalgo, Brooklyn, NY (US); Jakub Gruszecki, Sulechow (PL)

(21) Appl. No.: 18/129,281

(22) Filed: Mar. 31, 2023

(51) Int. Cl. G06Q 10/0639

(52) U.S. Cl. CPC G06Q 10/06395

(57) ABSTRACT

In one embodiment, a method performed by a computing device is provided. The method includes: (a) querying a set of data sources associated with a data service for historical telemetry data over a lookback period; (b) receiving the historical telemetry data from the set of data sources; (c) receiving an indication of a provisional service level objective (SLO) from a user via a user interface; (d) calculating an adherence of the data service to the provisional SLO with reference to the historical telemetry data; (e) displaying the calculated adherence to the user via the via the user interface; (f) receiving a setting of an SLO for the data service from the user via the user interface; and (g) setting the SLO according to the received setting. A corresponding computer program product, apparatus, and system using the method are also provided.

### BACKGROUND

Data services such as websites, databases, etc., provide responses to queries from users. In order to analyze how well a data service performs over time, service level indicators (SLIs) may be measured and compared to service level objectives (SLOs) set in advance. An SLI may be defined as a service threshold (e.g., successful response, response within a threshold time, etc.) and a percent adherence to that service threshold over a defined period of time. For example, one SLI may be a successful query response rate of 99% over the course of a month. Another example SLI may be a query return rate below 200 milliseconds (ms) at least 95% of the time over the course of a year.

### SUMMARY

Although SLOs are a very useful tool for analyzing performance of a data service, they are only useful if set in a meaningful manner. Unfortunately, it may be rather difficult for a system administrator to set effective SLOs.

Thus, it would be desirable to provide a tool to allow a user to gather and view historical telemetry data associated with how a data service has performed in the past and to be able to use that past data to set effective SLOs. This may be accomplished by gathering historical telemetry data from a set of data sources, calculating and displaying a historical adherence of the data service to a provisional SLO set by a user with reference to the gathered historical telemetry data, and allowing the user to set the SLO based on the calculated adherence of the provisional SLO. In some embodiments, statistics are calculated to allow the user to make an informed decision about how to set the provisional SLO. In some embodiments, the tool makes a recommendation for the provisional SLO with reference to the calculated statistics. In some embodiments, an error budget is calculated to allow a user to view compliance with the SLO.

In one embodiment, a method performed by a computing device is provided. The method includes: (a) querying a set of data sources associated with a data service for historical telemetry data over a lookback period; (b) receiving the historical telemetry data from the set of data sources; (c) receiving an indication of a provisional service level objective (SLO) from a user via a user interface; (d) calculating an adherence of the data service to the provisional SLO with reference to the historical telemetry data; (e) displaying the calculated adherence to the user via the via the user interface; (f) receiving a setting of an SLO for the data service from the user via the user interface; and (g) setting the SLO according to the received setting. A corresponding computer program product, apparatus, and system using the method are also provided.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments.

FIG. 1 illustrates an example system, apparatus, and computer program product for use in connection with one or more embodiments.

FIG. 2 illustrates an example method in accordance with one or more embodiments.

FIG. 3 illustrates an example method in accordance with one or more embodiments.

### DETAILED DESCRIPTION

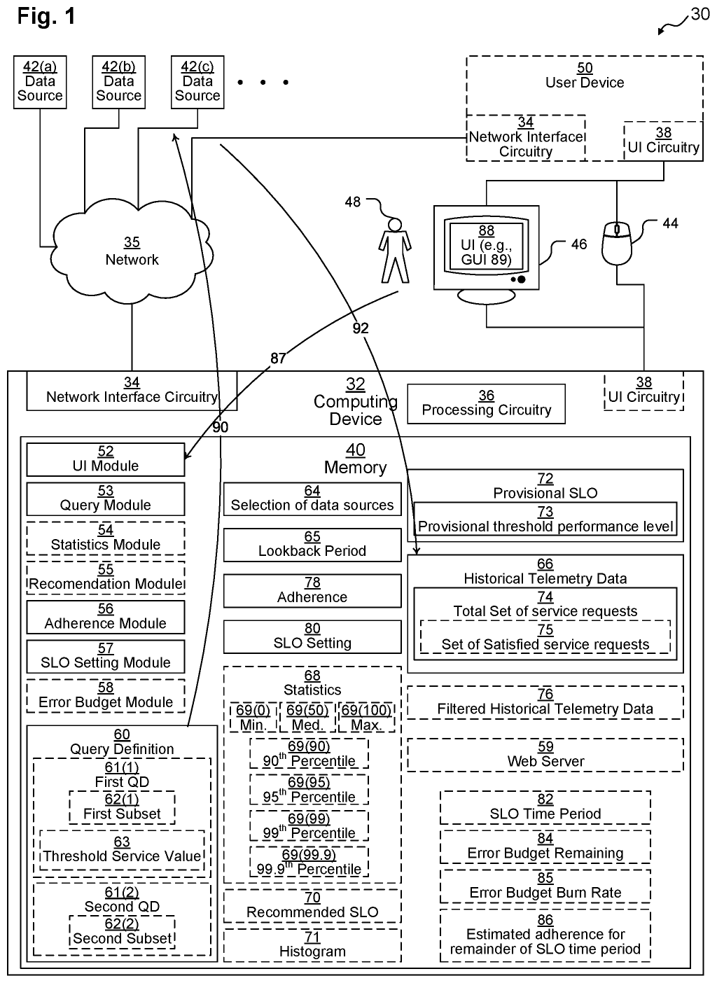

FIG. 1 depicts an example system 30 for use in connection with various embodiments. System 30 includes a computing device 32 connected to a set of data sources 42 (depicted as data sources 42(a), 42(b), 42(c), . . . ) via a network 35 and connected to a set of UI devices 44, 46. In some embodiments, system 30 may also include a remote user device 50.

Network 35 may be any kind of communications network or set of communications networks, such as, for example, a LAN, WAN, SAN, the Internet, a wireless communication network, a virtual network, a fabric of interconnected switches, etc.

Both computing device 32 and remote user device 50 may be any kind of computing device, such as, for example, a personal computer, laptop, workstation, server, enterprise server, tablet, smartphone, etc. Both computing device 32 and remote user device 50 may include processing circuitry 36, network interface circuitry 34, and memory 40. In addition, at least one of computing device 32 and remote user device 50 also includes user interface (UI) circuitry 38 for connecting to a UI input device 44 and a display device 46. Both computing device 32 and remote user device 50 may also include various additional features as is well-known in the art, such as, for example, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 34 may include one or more Ethernet cards, cellular modems, Fibre Channel (FC) adapters, InfiniBand adapters, wireless networking adapters (e.g., Wi-Fi), and/or other devices for connecting to a network 35.

UI circuitry 38 may include any circuitry needed to communicate with and connect to one or more user input devices 44 and display screens 46 operated by a user 48. UI circuitry 38 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 46 may be any kind of display, including, for example, a CRT screen, LCD screen, LED screen, etc. Input device 44 may include a keyboard, keypad, mouse, trackpad, trackball, pointing stick, joystick, touchscreen (e.g., embedded within display screen 46), microphone/voice controller, etc. In some embodiments, instead of being external to computing device 32 or remote user device 50, the input device 44 and/or display screen 46 may be embedded within the computing device 32 or remote user device 50 (e.g., a cell phone or tablet with an embedded touchscreen). Display screen 88 is configured to display a UI 88, such as a graphical UI (GUI) 89 or a text-based UI.

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

Memory 40 of computing device 32 stores a UI module 52, which is configured to operate on processing circuitry 36 of computing device 32 to communicate with user 48 via UI circuitry 38, display 46, and input device 44. In some embodiments, instead of user 48 directly interacting with computing device 32 via display 46, input device 44, and UI circuitry 38 of computing device 32, user 48 may interact with remote user device 50 via display 46, input device 44, and UI circuitry 38 of remote user device 50. In those embodiments, remote user device 50 may operate a web browser (not depicted) or other software configured to communicate with a web server 59 operating on computing device 32. Thus, user 48 is able to communicate with UI module 52 via web server 59 and user device 50. In these embodiments, memory 40 of computing device 32 also stores web browser 59.

Memory 40 of computing device 32 also stores a Query module 53, an Adherence module 56, and a Service Level Objective (SLO) Setting module 57, which are configured to operate on processing circuitry 36 of computing device 32. In some embodiments, memory 40 of computing device 32 also stores a statistics module 54, a recommendation module 55, and/or an error budget module 58, which are also configured to operate on processing circuitry 36 of computing device 32.

Memory 40 of computing device 32 also stores certain data, including a query definition (QD) 60, a selection 64 of particular data sources 42, a lookback period 65, historical telemetry data 66 received as signal(s) 92 from the particular data sources 42 identified by selection 64, a provisional SLO 72 input by user 48, an adherence value 78, and an SLO setting 80. Provisional SLO 72 includes a provisional threshold performance level 73.

QD 60 is sent to the particular data sources 42 identified by selection 64 as signal(s) 90. In some embodiments, QD 60 may actually be made up of two sub-QDs 61(1), 61(2). First QD 61(1) includes a first subset 62(1) of the selection 64 of particular data sources 42, and second QD 61(2) includes a first subset 62(2) of the selection 64 of particular data sources 42. It should be understood that these subsets 62 may or may not overlap or be identical. Each subset 62 includes at least one element identifying a data source 42, and each subset may include up to (and including) as many data sources 42 as identified by selection 64. First QD 61(1) also includes a threshold service value 63 (e.g., served successfully, served within 100 ms, served within 400 ms, etc.). First QD 61(1) serves to query the data sources 42 identified by the first subset 62(1) for all service requests of a particular type (e.g., all requests to access a web page served by a particular web server for a particular domain) that were fulfilled in accordance with the threshold service value 63. Second QD 61(2) serves to query the data sources 42 identified by the second subset 62(2) for all service requests of a particular type (e.g., all requests to access a web page served by a particular web server for a particular domain) that were made by eligible devices, regardless of whether they were served successfully. In some cases, the same data sources 42 may be queried for both. However, in certain situations (e.g., if some of the requests never even reached the web server), the data sources 42 having information about successful fulfilment may not have enough information about ALL service requests, so a different set of data sources 42 may be queried in connection with the two QDs 61(1), 61(2). In other embodiments, only the second QD 61(2) is part of QD 60, filtering by service value to be performed later.

Historical telemetry data 66 includes a total set 74 of service requests (e.g., the response to second QD 61(2)). In some embodiments, historical telemetry data 66 also includes a set 75 of satisfied service requests (e.g., the response to first QD 61(1), which should be a subset of total set 74).

In some embodiments, memory 40 of computing device 32 may also store statistics 68, a recommended SLO 70, a histogram 71, filtered historical telemetry data 76 (similar to the set 75 of satisfied service requests but filtered locally by adherence module 56), an SLO time period 82, an error budget remaining 84, an error budget burn rate 85, and an estimated adherence 86 for the remainder of the SLO time period 82.

In operation, query module 53 generates QD 60 based on user input 87, sends corresponding query signal(s) 90 to data sources 42, and receives corresponding query response(s) 92 from data sources 42 to store as the historical telemetry data 66. In some embodiments, QD 60 is defined over a lookback period 65 (e.g., 2 weeks, 30 days, etc.). Lookback period 65 defines the length of time over which the historical telemetry data 66 in the query response(s) 92 covers.

In some embodiments, statistics module 54 calculates statistics 68 about the historical telemetry data 66 such as a set of percentiles 69 (e.g., minimum service value 69(0), median service value 69(50), 90th percentile service value 69(90), 95th percentile service value 69(95), 99th percentile service value 69(99), 99.9th percentile service value 69(99.9), and maximum service value 69(100)). In some embodiments, recommendation module 55 determines a recommended SLO 70 to present to the user 48 via the UI 88. In some embodiments, statistics module 54 creates a histogram 71 by binning service values from the historical telemetry data 66. In some embodiments, UI module 52 displays the calculated statistics 68 and/or the histogram 71 to the user 48 via the GUI 89.

UI module 52 is also configured to receive from user 48 an indication of a provisional SLO 72 via UI devices 44, 46. This indication may include a provisional threshold performance level 73 (e.g., 200 ms). In some embodiments, the indication may also include a target adherence (e.g., 99%).

Adherence module 56 is configured to determine the adherence 78 of the received historical telemetry data 66 to the provisional SLO 72 over the lookback period 65. In some embodiments, adherence module 56 calculates adherence 78 by dividing the number of elements in the set 75 of satisfied service requests by the number of elements in the total set 74 of service requests. In other embodiments, adherence module 56 first performs a filtering operation to remove elements from the total set 75 of service requests 74 that do not satisfy the provisional threshold performance level 73, yielding filtered historical telemetry data 76. Then, adherence module 56 divides the number of elements in the filtered historical telemetry data 76 by the number of elements in the total set 74 of service requests.

UI module 52 is configured to display the calculated adherence 78 to the user 48 via UI 88 and to receive an SLO setting 80 from the user 48 in response. SLO setting module 57 is configured to take the SLO setting 80 and implement it as an SLO for the system 30.

In some embodiments, error budget module 58 is configured to calculate a remaining error budget 84 left in an SLO time period 82 after the lookback period 65. For example, if the lookback period is 2 weeks and the SLO time period 82 is 30 days, then the error budget 84 represents how many failed service requests (i.e., service requests that do not satisfy the performance level of the SLO setting 80) there can be or a percentage of expected service requests that can fail over the next 16 days (i.e., 30 days minus 16 days). In some embodiments, error budget module 58 is also configured to calculate an error budget burn rate 85, which represents how many failed service requests are expected per unit of time (e.g., per day) based on current trends. In some embodiments, error budget module 58 is also configured to calculate an estimated adherence 86 for the remainder of the SLO time period 82 after the lookback period 65. Estimated adherence 86 may be a set of values representing the expected value of the adherence 78 up to that point for each day in the remainder of the SLO time period 82 after the lookback period 65.

Memory 40 may also store various other data structures used by the OS, web server 59, modules 52-58, and/or various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32, 50 is powered off. The OS, web server 59, modules 52-58, and/or various other applications and drivers are typically stored in this persistent storage portion of memory 40 so that they may be loaded into a system portion of memory 40 upon a system restart or as needed. The OS, web server 59, modules 52-58, and/or various other applications and drivers, when stored in non-transitory form either in the volatile or persistent portion of memory 40, each form a computer program product. The processing circuitry 36 running one or more applications thus forms a specialized circuit constructed and arranged to carry out the various processes described herein.

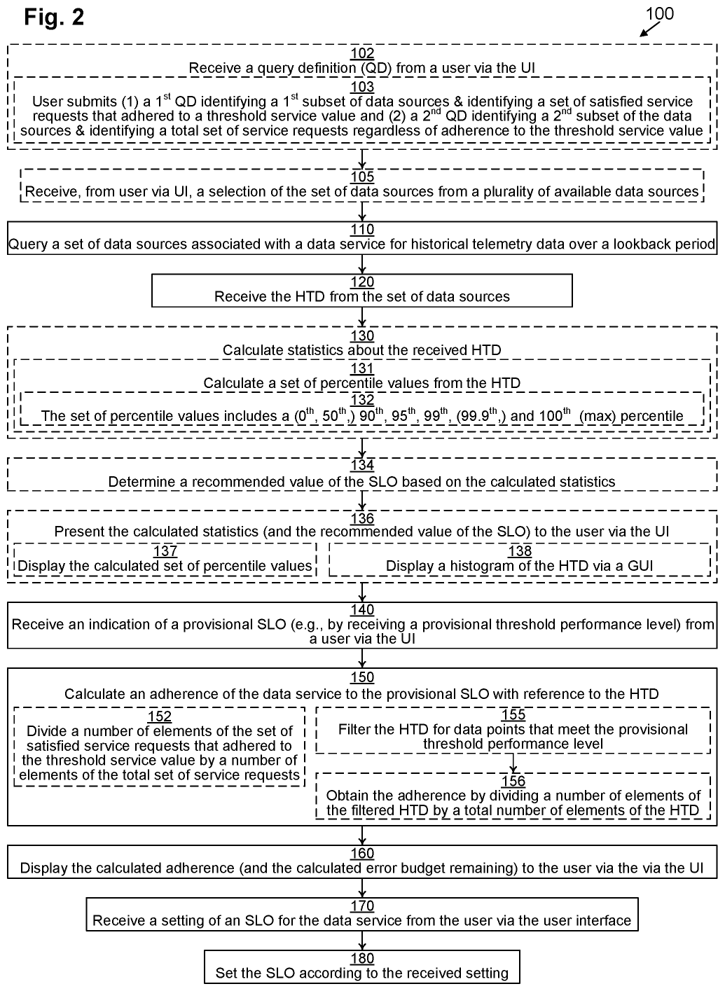

FIG. 2 illustrates an example method 100 performed by a computing device 32 for setting an SLO for a data service. It should be understood that any time a piece of software (e.g., OS, web server 59, modules 52-58, etc.) is described as performing a method, process, step, or function, what is meant is that a computing device (e.g., computing device 32 or remote user device 50) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order.

In some embodiments, method 100 may begin with steps 102 and 105, while in other embodiments, method 100 may begin with step 110.

In step 102, UI module 52 receives a QD 60 from the user 48 via the UI 88. In some embodiments, step 102 may include the user 48 using input device 44 to enter the QD 60 and have it received by UI circuitry 38 of computing device 32. In other embodiments, step 102 may instead include the user 48 using input device 44 to enter the QD 60, the UI circuitry 38 of user device 50 receive it and send a signal 87 from network interface 34 of user device 50 to network interface 34 of computing device 32 over network 35, with the involvement of a web browser (not depicted) operating on user device 50 and web server 59 operating on computing device 32. QD 60 includes a selection 64 of which data sources 42 to query.

In some embodiments (sub-step 103), the QD 60 submitted by the user 48 includes both a first QD 61(1) and a second QD 61(2). First QD 61(1) identifies a first subset 62(1) of data sources 42 and defines a set 75 of satisfied service requests that adhered to a threshold service value 63. Second QD 61(2) identifies a second subset 62(2) of the data sources 42 and defines a total set 74 of service requests regardless of adherence to the threshold service value 63. In other embodiments, QD 60 only includes second QD 61(2) without first QD 61(1).

In some embodiments (step 105), the selection 64 of which data sources 42 to query is defined by the user 48 selecting which data sources 42 belong in each subset 62.

In step 110, query module 53 queries a set of data sources 42 associated with a particular data service (e.g., data sources that record metadata about requests to a set of one or more web servers) for historical telemetry data 66 over a lookback period 65 by sending one or more query signals 90 to the data sources 42 identified by selection 64. In embodiments in which step 102 was performed, the QD 60 defined by the user 48 is used to perform the query or queries, and only the subsets 62 of the data sources 42 identified in the QD 60 are queried.

In response, in step 120, query module 53 receives query responses 92 from the queried data sources 42 containing the historical telemetry data (HTD) 66.

In some embodiments, in step 130, statistics module 54 calculates statistics 68 about the received HTD 66. In some embodiments, step 130 includes sub-step 131. In sub-step 131, statistics module 54 calculates a set of percentile values 69 from the HTD 66. In sub-step 132, the set of percentile values 69 includes one or more of minimum service value 69(0), median service value 69(50), 90th percentile service value 69(90), 95th percentile service value 69(95), 99th percentile service value 69(99), 99.9th percentile service value 69(99.9), and maximum service value 69(100). In one example embodiment, the set of percentile values 69 includes only the 90th percentile service value 69(90), 95th percentile service value 69(95), 99th percentile service value, 69(99), and maximum service value 69(100). In some embodiments (not depicted), calculated statistics 68 may also include a standard deviation.

In some embodiments, in step 134, recommendation module 55 determines a recommended SLO 70 based on the calculated statistics 68. For example, if the 95th percentile service value 69(95) is equal to 190 ms, then the recommendation module 55 may set the recommended SLO 70 to be equal to a service level of 200 ms at least 95% of the time over a period of 30 days.

In some embodiments, in step 136, UI module 52 presents the calculated statistics 68 (and the recommended SLO 70 if step 134 was performed) to the user 48 via the UI 88. In some embodiments, step 136 includes sub-step 137, in which UI module 52 displays the calculated set of percentile values 69. In some embodiments, statistics module 54 creates a histogram 71 by binning service values from the historical telemetry data 66, and in sub-step 138, UI module 52 displays the histogram 71 to the user 48 via the GUI 89.

In step 140, UI module 52 receives an indication of a provisional SLO 72 from user 48 via UI input device 44. This indication may include a provisional threshold performance level 73 (e.g., 200 ms). In some embodiments, the indication may also include a target adherence (e.g., 99%).

In step 150, adherence module 56 calculates an adherence 78 of the data service at issue to the provisional SLO 72 with reference to the HTD 66. In some embodiments, step 150 includes sub-step 152. In other embodiments, step 150 includes sub-steps 155, 156.

In sub-step 152, adherence module 56 divides a number of elements of the set 75 of satisfied service requests that adhered to the threshold service value 63 by a number of elements of the total set 74 of service requests.

In sub-step 155, adherence module 56 filters the HTD 66 for data points that meet the provisional threshold performance level 73, yielding filtered HTD 76. Then, in sub-step 156, adherence module 56 obtains the adherence 78 by dividing a number of elements of the filtered HTD 76 by a total number of elements of the HTD 66 (e.g., the number of elements of the total set 74 of service requests).

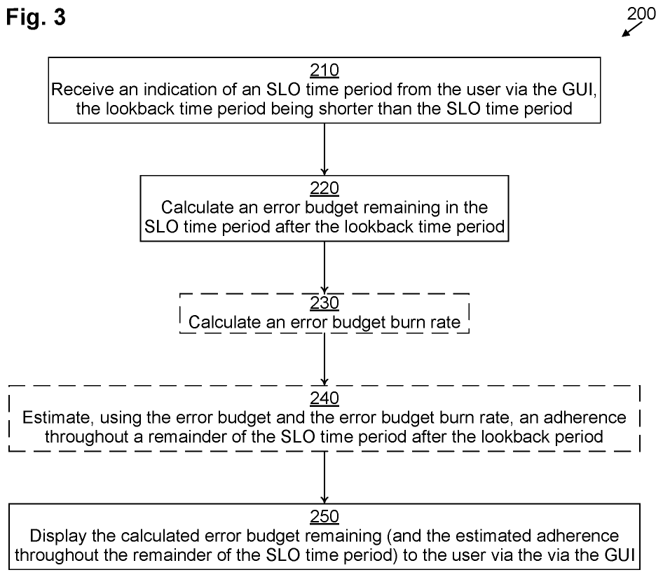

In step 160, UI module 52 displays the calculated adherence 78 to the user 48 via the UI 88. In some embodiments, UI module 52 also displays the calculated error budget remaining 84 (see FIG. 3) to the user 48 via the UI 88.

In step 170, UI module 52 receives an SLO setting 80 from user 48 via UI input device 44, and in step 180, SLO setting module 57 sets the SLO for the data service according to the received SLO setting 80.

FIG. 3 depicts an example method 200. Method 200 includes various steps that may be performed by a computing device 32 for determining and displaying an error budget remaining 84 and/or an estimated adherence 86.

In step 210, UI module 52 receives an indication of an SLO time period 82 from the user 48 via the GUI 89, the lookback time period 65 being shorter than the SLO time period 82.

In step 220, error budget module 58 calculates a remaining error budget 84 left in the SLO time period 82 after the lookback period 65. For example, if the lookback period is 2 weeks and the SLO time period 82 is 30 days, then the error budget 84 represents how many failed service requests (i.e., service requests that do not satisfy the performance level of the SLO setting 80) there can be or a percentage of expected service requests that can fail over the next 16 days (i.e., 30 days minus 16 days).

In some embodiments, in step 230, error budget module 58 also calculates an error budget burn rate 85, which represents how many failed service requests are expected per unit of time (e.g., per day) based on current trends.

In some embodiments, in step 240, error budget module 58 also estimates an estimated adherence 86 throughout the remainder of the SLO time period 82 after the lookback period 65. Estimated adherence 86 may be a set of values representing the expected value of the adherence 78 up to that point for each day in the remainder of the SLO time period 82 after the lookback period 65.

Finally, in step 250, UI module 52 displays the calculated error budget remaining 84 (and the estimated adherence 86 throughout the remainder of the SLO time period 82 after the lookback period 65) to the user 48 via the via the GUI 89.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A method performed by a computing device, the method comprising:
querying a set of data sources associated with a data service for historical telemetry data over a lookback period;
receiving the historical telemetry data from the set of data sources;
receiving an indication of a provisional service level objective (SLO) from a user via a user interface;
calculating an adherence of the data service to the provisional SLO with reference to the historical telemetry data;
displaying the calculated adherence to the user via the via the user interface;
receiving a setting of an SLO for the data service from the user via the user interface; and
setting the SLO according to the received setting.

2. The method of claim 1, wherein the user interface is a graphical user interface (GUI), and the method further comprises:
calculating statistics about the received historical telemetry data; and
presenting the calculated statistics to the user via the GUI.

3. The method of claim 2 wherein the method further comprises, in response to calculating the statistics:
determining a recommended value of the SLO based on the calculated statistics; and
presenting the recommended value of the SLO to the user via the GUI prior to receiving the indication from the user.

4. The method of claim 2 wherein the method further comprises:
receiving an indication of an SLO time period from the user via the GUI, the lookback time period being shorter than the SLO time period;
calculating an error budget remaining in the SLO time period after the lookback time period; and
displaying the calculated error budget remaining to the user via the GUI.

5. The method of claim 4 wherein the method further comprises:
calculating an error budget burn rate;
estimating, using the error budget and the error budget burn rate, an adherence throughout a remainder of the SLO time period after the lookback period; and
displaying the estimated adherence throughout the remainder of the SLO time period to the user via the GUI.

6. The method of claim 2 wherein:
calculating the statistics includes calculating a set of percentile values from the historical telemetry data; and
presenting the calculated statistics to the user via the GUI includes displaying the calculated set of percentile values.

7. The method of claim 6 wherein the set of percentile values includes a 90th percentile, a 95th percentile, a 99th percentile, and a maximum value.

8. The method of claim 2 wherein presenting the calculated statistics to the user via the GUI includes displaying a histogram of the received historical telemetry data via the GUI.

9. The method of claim 1 wherein querying a set of data sources is performed in response to the user submitting a query definition via the user interface.

10. The method of claim 9 wherein the method further comprises receiving, from the user via the user interface, a selection of the set of data sources from a plurality of available data sources.

11. The method of claim 9 wherein:
the user submitting a query definition via the user interface includes the user submitting (1) a first query definition identifying a first subset of the data sources, the first query definition identifying a set of satisfied service requests that adhered to a threshold service value, and (2) a second query definition identifying a second subset of the data sources, the second query definition identifying a total set of service requests regardless of adherence to the threshold service value; and
calculating the adherence of the data service to the provisional SLO includes dividing a number of elements of the set of satisfied service requests that adhered to the threshold service value by a number of elements of the total set of service requests.

12. The method of claim 1 wherein:
receiving the indication of the provisional SLO from the user includes receiving a provisional threshold performance level from the user;
calculating the adherence of the data service to the provisional SLO includes:
filtering the historical telemetry data for data points that meet the provisional threshold performance level; and
obtaining the adherence by dividing a number of elements of the filtered historical telemetry data by a total number of elements of the historical telemetry data.

13. A system comprising:
a user interface;
a network connection connected to a network;
computing circuitry configured to:
query, over the network connection, a set of data sources associated with a data service for historical telemetry data over a lookback period;
receive, via the network connection, the historical telemetry data from the set of data sources;
receive an indication of a provisional service level objective (SLO) from a user via the user interface;
calculate an adherence of the data service to the provisional SLO with reference to the historical telemetry data;
display the calculated adherence to the user via the via the user interface;
receive a setting of an SLO for the data service from the user via the user interface; and
set the SLO according to the received setting.

14. The system of claim 13, wherein the user interface is a graphical user interface (GUI), and the computing circuitry is further configured to:
calculate statistics about the received historical telemetry data; and
present the calculated statistics to the user via the GUI.

15. A computer program product comprising a non-transitory computer-readable storage medium storing a set of instructions, which, when executed by processing circuitry of a computing device, cause the computing device to:
query a set of data sources associated with a data service for historical telemetry data over a lookback period;
receive the historical telemetry data from the set of data sources;
receive an indication of a provisional service level objective (SLO) from a user via a user interface;
calculate an adherence of the data service to the provisional SLO with reference to the historical telemetry data;
display the calculated adherence to the user via the via the user interface;
receive a setting of an SLO for the data service from the user via the user interface; and
set the SLO according to the received setting.

16. The computer program product of claim 15, wherein the user interface is a graphical user interface (GUI), and the instructions, when executed by the processing circuitry, further cause the computing device to:
calculate statistics about the received historical telemetry data; and
present the calculated statistics to the user via the GUI.
